(19) United States
(12) Patent Application Publication
(10) Pub. No.: US 2016/0203301 A1
(43) Pub. Date: Jul. 14, 2016

(54) LICENSE MANAGEMENT APPARATUS, LICENSE MANAGEMENT METHOD, AND LICENSE AUTHENTICATION PROGRAM

(71) Applicant: Yasuomi OOKI, Kawasaki-shi (JP)

(72) Inventor: Yasuomi OOKI, Kawasaki-shi (JP)

(21) Appl. No.: 15/076,092

(22) Filed: Mar. 21, 2016

Related U.S. Application Data
(62) Division of application No. 12/261,925, filed on Oct. 30, 2008.

(30) Foreign Application Priority Data
Nov. 1, 2007 (JP) 2007-285261

(51) Int. Cl. G06F 21/10

(52) U.S. Cl. CPC G06F 21/105

(57) ABSTRACT

An object of the present invention is to solve the following problems: a problem concerning the node lock license system in which when a license is given to only one hardware device, reissuance of the license is required every time a changeover of the hardware device to be used occurs; a problem concerning the node lock license system in which when a license is given to a plurality of hardware devices, the license fee is increased; a problem concerning the floating license system in which that when a client is in an environment where it cannot connect to the license server, the client cannot use intended software; and a problem concerning the floating license system in which that when a client malfunctions in a possessing state of the license, a procedure for license acquisition needs to be taken once again.

A license management apparatus includes: a means for performing license management using hardware unique information at the initial license management time; and a means for performing license management using only a user ID and a password at the second and subsequent license management times.

### CROSS-REFERENCE TO RELATED APPLICATIONS

This application is a Divisional of U.S. patent application Ser. No. 12/261,925, filed on Oct. 30, 2008, which claims priority from Japanese Patent Application No. 2007-285261 filed Nov. 1, 2007, the contents of all of which are incorporated herein by reference in their entirety.

### BACKGROUND OF THE INVENTION

1. Field of the Invention

The present invention relates to a license management apparatus, a license management method, and a license authentication program which are used for managing software license.

2. Description of the Related Art

License management has been an important issue in software applications because software is easy to copy. As an example of typical license management, there is known a license form (hereinafter, referred to as “node lock license”) that buries information unique to a hardware device onto which software is installed in a license key so as to allow the license key to become effective only for the corresponding hardware device.

However, the above technique has the following problem. That is, when the hardware device is replaced by another one due to a failure or the like, it is necessary to ask a license issuer to take procedures for transferring the license to the another hardware device, which involves great trouble. Further, in recent years, there have been many cases where one user retains a plurality of hardware devices which are changed over for use from one to another depending on the situation and intended use. If the node lock license is applied to such a case, it is necessary to ask a license issuer to take procedures for the license transfer every time the changeover is made, which is virtually impossible to put into practice.

There is available a method in which a software user registers hardware unique information corresponding to the number of the retained hardware devices in a system of the license issuer and acquires a license by which the relevant software can be used on a plurality of hardware devices at a time. However, there may be a rare case where one user uses a plurality of hardware devices at a time for software utilization. In most cases, the user uses the hardware device while changing over from one device to another, that is, the user uses only one device at a time. Even in this case, the license issuer has no choice but to charge license fee calculated in consideration of a possibility that the user uses the software on a plurality of hardware devices at a time, and the user is forced to pay expensive license fee.

To solve the above problem, there has been used a system called “floating license”. That is, a license management server for registering a license purchased by a user is installed in a system on the license issuer side or system on the user side. The user requires, as needed, the license server to send the license data and returns the license to the server when no longer necessary.
[Patent Document 1] JP2002-149606-A
[Patent Document 2] JP2003-162507-A
[Patent Document 3] JP2005-321850-A
[Patent Document 4] JP2006-059163-A

However, this system also has the following problems. Since a license is acquired on a first-come-first-served basis, there is a possibility that a case occurs where a user really wants the license cannot use it. Further, in order to prevent a specific user from being left in possession of the license over long periods, it is necessary to perform license renewal processing at comparatively short intervals, making it difficult for users in an environment (e.g., meeting room where a network environment is not available) where they cannot connect to the license server for a long time to use this system. To solve the above problems, there can be considered a method of extending the license renewal interval or issuing the license for an indefinite period. However, if this method is applied, there occurs not only a problem that other users cannot use the license but also a problem that when a hardware device malfunctions or lost in a state where the license corresponding to the relevant hardware device is being possessed by a given user, there needs to be performed a troublesome operation of canceling the issuance state of all the licenses once on the license management server and prompting the users to perform acquisition of the license once again.

The present invention aims to solve the above problems in a product like an exchange that provides both a server (exchange) and a client (terminal) in the user environment.

### SUMMARY OF THE INVENTION

That is, an object of the present invention is to solve the following problems:

a problem concerning the node lock license system in which when a license is given to only one hardware device, reissuance of the license is required every time a changeover of the hardware device to be used occurs;

a problem concerning the node lock license system in which when a license is given to a plurality of hardware devices, the license fee is increased;

a problem concerning the floating license system in which that when a client is in an environment where it cannot connect to the license server, the client cannot use intended software; and

a problem concerning the floating license system in which that when a client malfunctions in a possessing state of the license, a procedure for license acquisition needs to be taken once again.

According to a first aspect of the present invention, there is provided a license management apparatus that can change over a use terminal from one to another by confirming hardware unique information at the initial registration time of the terminal.

In the license management apparatus according to the first aspect of the present invention, an acquired node lock license may be made able to be changed into a floating license.

In the license management apparatus according to the first aspect of the present invention, a floating license mode may be made able to be implemented in the same processing as a node lock license system except for registration processing.

In the license management apparatus according to the first aspect of the present invention, a use terminal may be made able to be changed over from one to another without release/reacquisition of a used license even in the floating license mode.

In the license management apparatus according to the first aspect of the present invention, it may be made possible to change over a use terminal from one to another on a per software basis by registering a use hardware ID per software.

In the license management apparatus according to the first aspect of the present invention, it may be made possible to use a terminal to which a user ID has not been assigned by automatically generating the user ID based on a software identifier and software serial number.

In the license management apparatus according to the first aspect of the present invention, a default value of the software serial number may be made able to be disabled so as to prevent changeover processing of a use terminal from being erroneously performed at the time when a new terminal is installed.

According to a second aspect of the present invention, there is provided a license management apparatus including: a means for performing license management using hardware unique information at the initial license management time; and a means for performing license management using only a user ID and a password at the second and subsequent license management times.

According to the present invention, it is possible to solve the following problems: a problem concerning the node lock license system in which when a license is given to only one hardware device, reissuance of the license is required every time a changeover of the hardware device to be used occurs; a problem concerning the node lock license system in which when a license is given to a plurality of hardware devices, the license fee is increased; a problem concerning the floating license system in which that when a client is in an environment where it cannot connect to the license server, the client cannot use intended software; and a problem concerning the floating license system in which that when a client malfunctions in a possessing state of the license, a procedure for license acquisition needs to be taken once again.

### BRIEF DESCRIPTION OF THE DRAWINGS

FIG. 1 is a block diagram showing the entire configuration of a system according to an embodiment of the present invention;

FIG. 2 is a block diagram showing a configuration of a desk-top terminal, a mobile terminal, or a meeting room's terminal shown in FIG. 1;

FIG. 3 is a block diagram showing a configuration of an exchange shown in FIG. 1;

FIG. 4 is a block diagram showing a configuration of an optional terminal shown in FIG. 1;

FIG. 5 is a view showing an example of an internal configuration of a user database shown in FIG. 3;

FIG. 6 is a view showing an example of an internal configuration of a system database shown in FIG. 3;

FIG. 7 is a flowchart showing operation performed in the system shown in FIG. 1 at license registration time;

FIG. 8 is a flowchart showing operation performed in the system shown in FIG. 1 at terminal registration time;

FIG. 9 is a flowchart showing operation performed in the system shown in FIG. 1 at license authentication time;

FIG. 10 is a flowchart showing operation performed in the system shown in FIG. 1 at license acquisition request time; and

FIG. 11 is a flowchart showing operation performed in the system shown in FIG. 1 at license return request time.

### DETAILED DESCRIPTION OF THE PREFERRED EMBODIMENTS

A preferred embodiment for practicing the present invention will be described in detail below.

A system according to the present invention is the same as the node lock license system in terms of issuing a license based on hardware unique information, but differs from the same in the following point. That is, after inputting the license to an exchange, the system of the present invention checks the hardware unique information only when a terminal first accesses the exchange for acquisition of the license. That is, at the second and subsequent access times, the system determines success of license acquisition when authentication based on a user ID and a password succeeds even if the hardware unique information does not coincide and disables the previous hardware unique information.

This eliminates the need to change server-side settings or to reissue the license even if a use hardware device is changed from one to another due to hardware malfunction or depending on usage, thereby solving the problems lying in the node lock license system and providing a system of the present invention while utilizing the advantages of the conventional node lock license system.

Further, by using a fixed user ID, the present invention can be applied to software operating on an optional hardware terminal of an exchange having a limited input means of a user ID or a password.

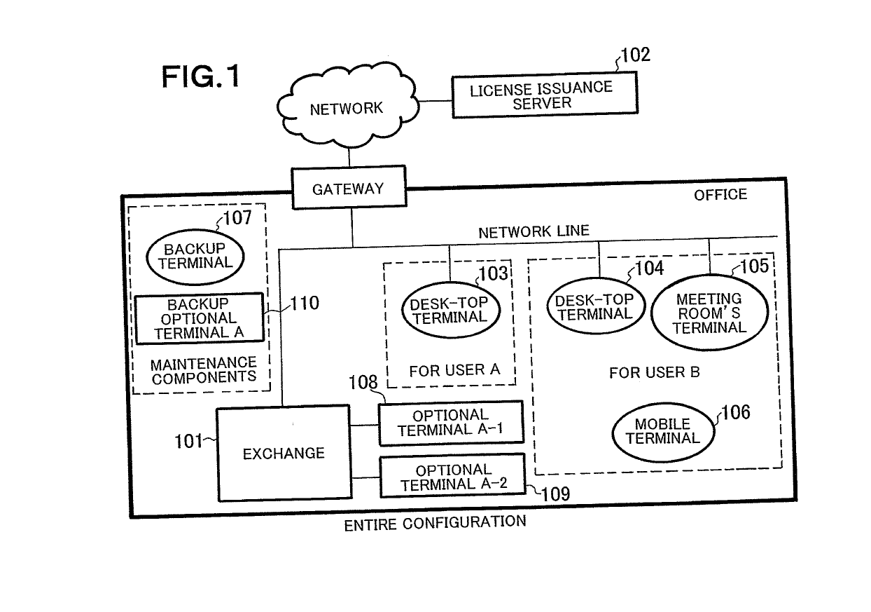

As an embodiment of the present invention, a configuration in which an exchange and its terminals are set in an office will be described with reference to FIG. 1.

There exist in the office an exchange 101 for exchanging communication, a desk-top terminal 103 for user A connected to a network line, a desk-top terminal 104 for user B connected to a network line, a meeting room's terminal 105, a mobile terminal 106 connected by radio to a network line, a first optional terminal A-1 108 of the exchange connected to the exchange 101, a second optional terminal A-2 109, a backup terminal 107 for maintenance used in the case where the terminals or optional terminals malfunction, and a backup optional terminal A 110.

Further, a license issuance server 102 for issuing a license exists on a public network and connected to the office network via a gateway.

The exchange 101 communicates with the terminals 103 to 107 and optional terminals 108 to 110 and controls their communication connections.

The license issuance server 102 issues a license key to be input to the exchange. Although the license issuance server 102 is connected to the office network via a gateway in the present embodiment, it need not always be connected to the office network.

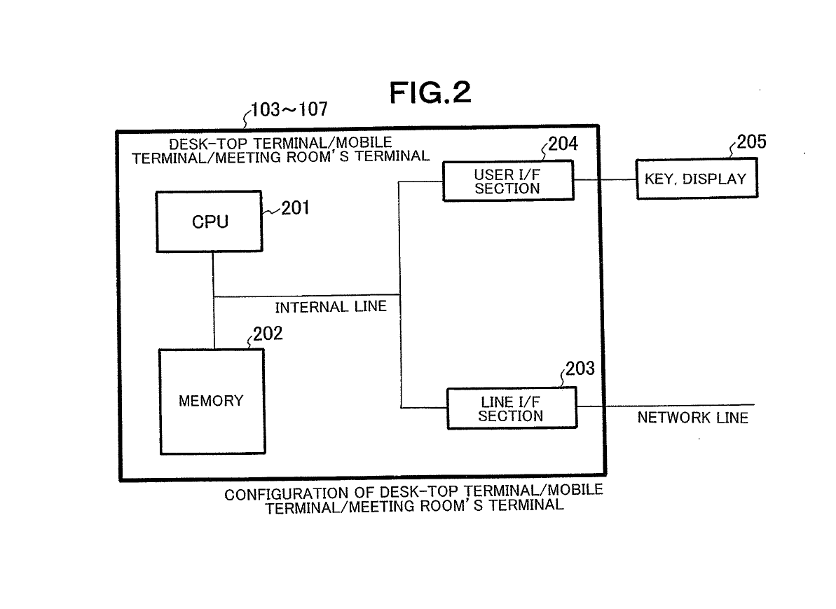

With reference to FIG. 2, operation of the terminals 103 to 107 will roughly be described. A user I/F section 204 receives an input signal from a key or mouse connected thereto and outputs a video signal to a display. A line I/F section 203 exchanges a signal with the network line. A CPU 201 controls the entire operation of each terminal. A memory 202 serves as a work area when software or data required for controlling the operation of each terminal is used.

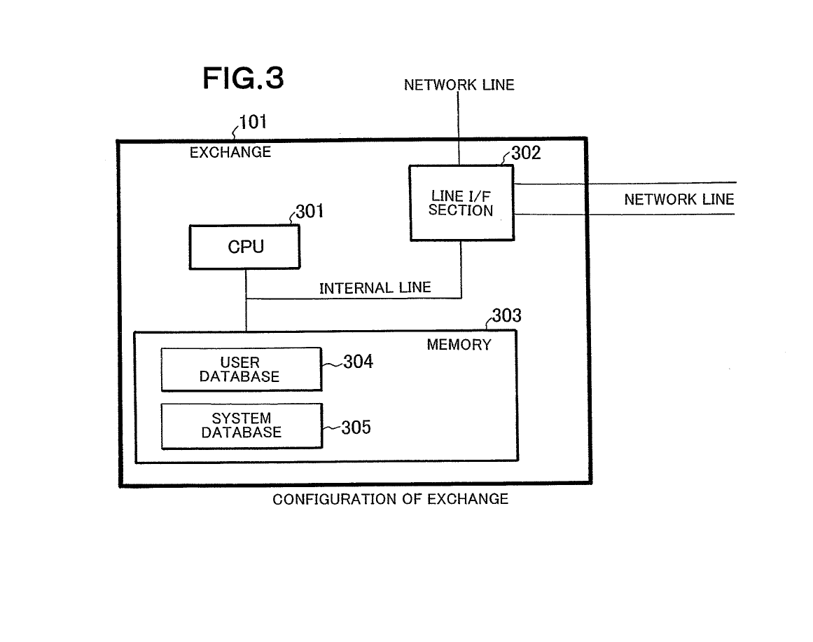

With reference to FIG. 3, operation of the voice exchange 101 will roughly be described. A line I/F section 302 exchanges a signal with the network line. A CPU 301 controls the entire operation of the exchange 101. A memory 303 serves as a work area when software or data required for controlling the operation of the exchange 101 is used. A user database 304 and a system database 305 each serve as an area for retaining various setting data stored in the memory 303.

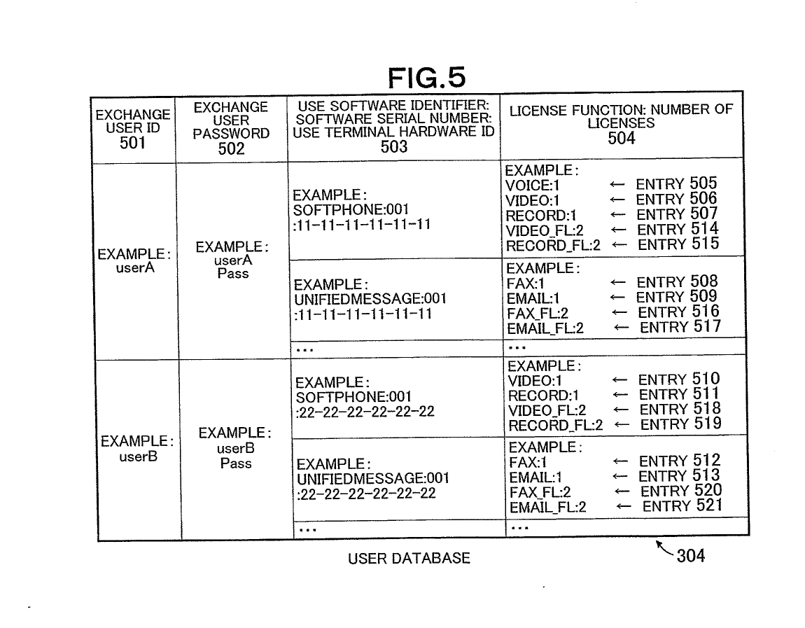

FIG. 5 shows the content of the user database 304 stored in the memory 305 of the exchange 101. Exchange user ID 501 stores ID information of a user currently using the exchange 101. Exchange user password 502 stores a password corresponding to the user ID. Use software identifier: Software serial number: Use terminal hardware ID 503 stores an identifier of software that the user currently using the exchange 101, serial numbers of software for identifying the software in the case where a plurality of the same software are used at the same time, and unique hardware information of a hardware device on which the user uses the software. License function: Number of licenses 504 stores, among function of the software listed in 503, a function that has been licensed and the number of the licensed functions.

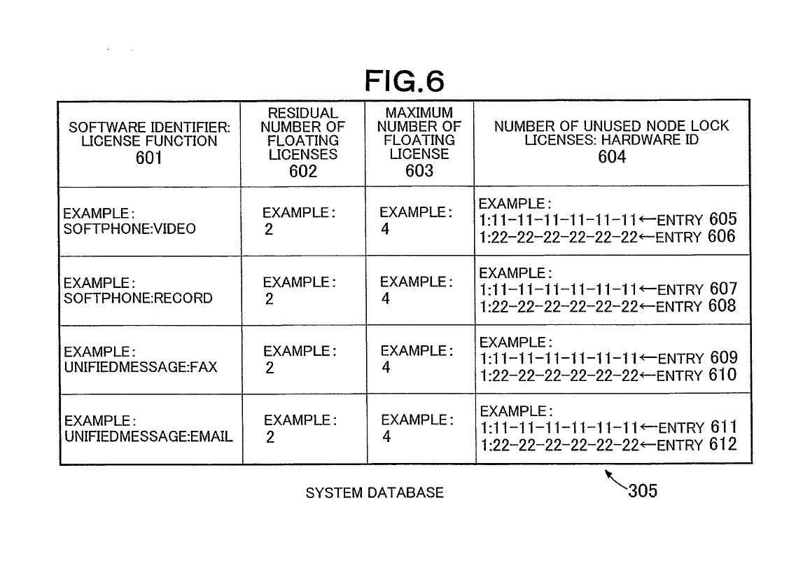

FIG. 6 shows the content of the system database 305 stored in the memory 303 of the voice exchange 101. Residual number of floating licenses 602 and maximum number of floating licenses 603 each are an area for storing floating licenses and, more specifically, stores the residual number of the floating licenses that the user has not yet acquired and total number of issued licenses with respect to corresponding Software identifier: License function 601. Number of unused node lock licenses: Hardware ID 604 is an area for temporarily storing a node lock license that has never been used since its issuance and, more specifically, stores the number of unused node lock licenses and hardware device ID that has been applied for at the time of purchase of the license with respect to corresponding Software identifier: License function 601.

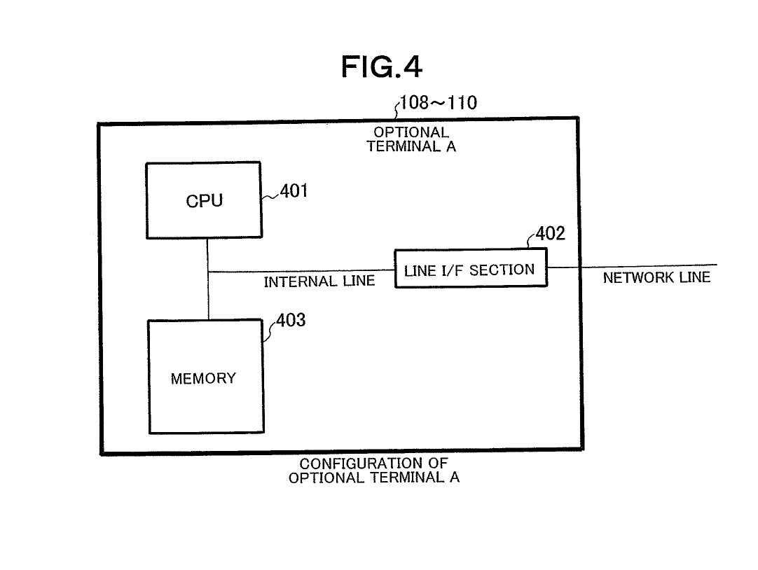

With reference to FIG. 4, operation of the optional terminals 108 to 110 will roughly be described. A line I/F section 402 exchanges a signal with the network line. A CPU 401 controls the entire operation of each optional terminal. A memory 403 serves as a work area when software or data required for controlling the operation of each terminal is used.

Next, operation of the present embodiment will concretely be described.

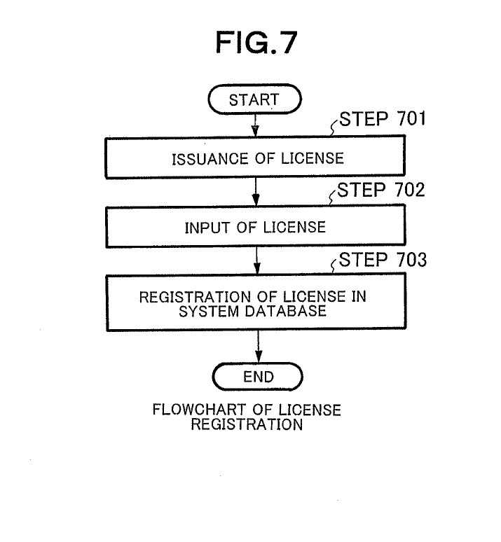

With reference to a flowchart of FIG. 7, a case where a license key is issued by the license issuance server 102 and is then input to the exchange 101 will be described.

A user purchases a license and notifies a license issuer of a hardware ID of a terminal on which a software function corresponding to the license is used. The license issuer inputs the received hardware ID to the license issuance server 102, and the license issuance server 102 issues a node lock license key including the hardware ID information. Alternatively, the user may directly access the license issuance server 102 for acquisition of the node lock license key using a terminal on which a software function corresponding to the license is used. In this case, the hardware ID is automatically transmitted to the license issuance server 102. It is assumed, in the present embodiment, that a user A uses the desk-top terminal 103 with a hardware ID of “11-11-11-11-11-11” to purchase one “VIDEO” function and one “RECORD” function of software with software identifier of “SOFTPHONE” and one “FAX” function and one “EMAIL” function of software with software identifier of “UNIFIEDMESSAGE” and receives issuance of corresponding node license keys and that a user B uses the desk-top terminal 104 with a hardware ID of “22-22-22-22-22-22” to purchase one “VIDEO” function and one “RECORD” function of software with software identifier of “SOFTPHONE” and one “FAX” function and one “EMAIL” function of software with software identifier of “UNIFIEDMESSAGE” and receives issuance of corresponding node lock license keys (step 701).

Then, a system administrator or the like inputs the issued node lock license keys to the exchange 101 (step 702).

The exchange 101 that has received the input of the license keys stores the input license keys in the system database 305. Since the licenses that have been input are the node lock licenses, they are stored in Number of unused node lock licenses: Hardware ID storage area 604 of the corresponding Software identifier: License function 601. In the present embodiment, the hardware ID “11-11-11-11-11-11” of the desk-top terminal 103, hardware ID “22-22-22-22-22-22” of the desk-top terminal 104, and the number of purchases are stored in Number of unused node lock licenses: Hardware ID storage area 604 of the corresponding Software identifier: License function 601 (step 703).

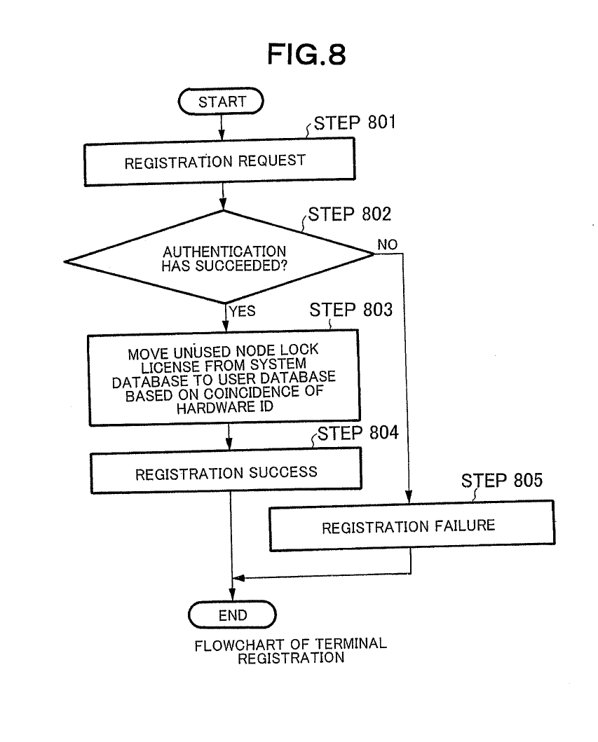

Next, with reference to a flowchart of FIG. 8, a case where each of the terminals 103 to 106 registers itself in the exchange 101 as a terminal that execute the software function corresponding to the purchased license at its activation time or reset time will be described.

It is assumed that the user B uses the desk-top terminal 104 to execute software with a software identifier of “SOFTPHONE” for the first time after the input of the license. After activation, the desk-top terminal 104 transmits its own hardware ID “22-22-22-22-22-22”, user ID “user B” of the user B, password “userBPass”, software identifier “SOFTPHONE”, and software serial number to the exchange 101 (step 801). The software serial number in this case is “001” since only one software with a software identifier of “SOFTPHONE” is executed.

The exchange 101 checks whether the received user ID and password coincide with those stored in the user database 304 (step 802).

When the received user ID and password do not coincide with those stored in the user database 304, the exchange 101 determines that the authentication has failed and transmits the fact of the authentication failure to the terminal 104 (step 805).

It is assumed that the received user ID and password coincide with those stored in the user database 304. In this case, the exchange 101 stores the received hardware ID “22-22-22-22-22-22” in the use terminal hardware ID corresponding to the received software identifier “SOFTPHONE” of the license information storage area 503 of the user B of the user database 304.

Thereafter, the exchange 101 searches the system database 305 to check whether an entry including the hardware ID “22-22-22-22-22-22” of the desk-top terminal 104 exists in the unused node lock license storage area 604 corresponding to the received software identifier “SOFTPHONE” of 601. If exists, the exchange moves data in the 604 to Use software identifier: Software serial number: Use terminal hardware ID 503 of the user database 304 and license storage area 504 of the corresponding user, corresponding software identifier and corresponding software serial number. In this case, the exchange 101 moves entries 606 and 608 each including the software identifier “SOFTPHONE” of 601 and hardware ID “22-22-22-22-22-22” of 604 to entries 510 and 511 (step 803).

Thereafter, the exchange 101 transmits the fact of the authentication success to the terminal 104 (step 804).

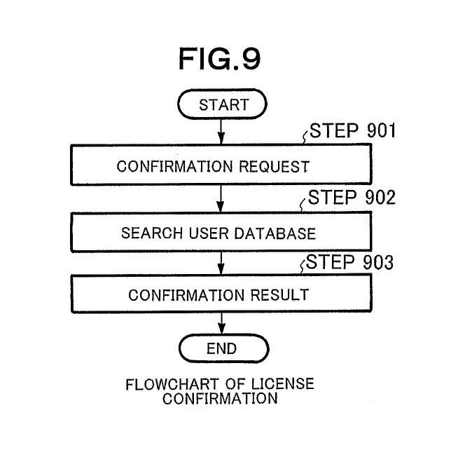

Next, with reference to a flowchart of FIG. 9, a case where the software on the terminal confirms the user holding license with the exchange after the terminal registration procedure to enable the licensed function will be described.

It is assumed that the user B uses the desk-top terminal 104 to execute software with a software identifier of “SOFTPHONE” for utilizing the functions “VIDEO” and “RECORD”. After the software “SOFTPHONE” on the desk-top terminal 104 is activated and its registration is succeeded, the software transmits to the exchange 101 a holding license confirmation request together with its own hardware ID “22-22-22-22-22-22”, user ID “UserB” of the user B, password “userBPass”, software identifier “SOFTPHONE”, and software serial number “001” (step 901).

The exchange 101 searches the license storage area 504 of the user database 304 corresponding to the received user ID “UserB” of the user B, password “userBPass”, hardware ID “22-22-22-22-22-22”, software identifier “SOFTPHONE”, and software serial number “001” and finds the entries 510 and 511 as a result of the search (step 902).

The exchange 101 transmits license function and number of licenses of the entries 510 and 511 to the terminal 104 as the confirmation result. In this case, function “VIDEO” and the number of licenses “1” thereof and function “RECORD” and the number of licenses “1” thereof are transmitted. Upon reception of the confirmation result, the software “SOFTPHONE” enables the function “VIDEO” and function “RECORD” (step 903). When a plurality of functions are executed at the same time, a corresponding number of licenses are required.

Next, with reference to the flowchart of FIG. 8, a case where a use terminal is changed over from one to another registered terminal due to hardware malfunction or depending on usage will be described.

It is assumed that the user B using the software “SOFTPHONE” on the desk-top terminal 104 temporarily uses the meeting room's terminal 105.

After activation, the meeting room's terminal 105 transmits to the exchange 101 its own hardware ID “33-33-33-33-33-33”, user ID “UserB” of the user B, password “userBPass”, software identifier “SOFTPHONE”, and software serial number “001” (step 801). The software serial number in this case is “001” since only one software with a software identifier of “SOFTPHONE” is executed.

The exchange 101 checks whether the received user ID and password coincide with those stored in the user database 304 (step 802).

When the received user ID and password do not coincide with those stored in the user database 304, the exchange 101 determines that the authentication has failed and transmits the fact of the authentication failure to the meeting room's terminal 105 (step 805).

It is assumed that the received user ID and password coincide with those stored in the user database 304. In this case, the exchange 101 stores the received hardware ID “33-33-33-33-33-33” in the use terminal hardware ID corresponding to the received software identifier “SOFTPHONE” of the license information storage area 503 of the user B of the user database 304.

Thereafter, the exchange 101 searches the system database 305 to check whether an entry including the hardware ID “33-33-33-33-33-33” of the meeting room's terminal 105 exists in the unused node lock license storage area 604 corresponding to the received software identifier “SOFTPHONE” of 601. Since such an entry does not exist in this case, the exchange 101 does not perform any processing (step 803).

Thereafter, the exchange 101 transmits the fact of the authentication success to the meeting room's terminal 105 (step 804).

At this time, the desk-top terminal 104 may immediately be disabled in terms of availability of the relevant software through a notification of a registration cancel message sent from the exchange 101. However, it is determined that the hardware ID of the desk-top terminal 104 does not coincide with that of 503 by the license confirmation processing of FIG. 9 periodically executed on the desk-top terminal 104, so that the availability is automatically disabled.

Thereafter, by executing the license confirmation processing shown in FIG. 9, it is possible to utilize the function that has been utilized on the desk-top terminal 104 on the meeting room's terminal 105, as well as to disable the desk-top terminal 104 in terms of the availability of the relevant software.

Further, since the hardware ID of the use terminal is registered per software identifier, the user B can continue using the terminal before the changeover (in this case, the desk-top terminal 104) to execute software with a different software identifier from “SOFTWARE”.

Next, a case where the floating license system is realized in the present system will be described.

With reference to the flowchart of FIG. 7, a case where a license key is issued by the license issuance server and is then input to the exchange will be described.

A user purchases a license and notifies a license issuer of the maximum number of hardware devices that use the function at the same time. The license issuer inputs the received maximum number to the license issuance server 102, and the license issuance server 102 issues a floating license key including the maximum number information. Alternatively, the user may directly access the license issuance server 102 for acquisition of the floating license key by inputting the maximum number. It is assumed, in the present embodiment, that a user purchases a “VIDEO” function and a “RECORD” function of software with software identifier of “SOFTPHONE” with a maximum number of 4, respectively and a “FAX” function and an “EMAIL” function of software with software identifier of “UNIFIEDMESSAGE” with a maximum number of 4, respectively and receives issuance of corresponding floating license keys (step 701).

Then, a system administrator or the like inputs the issued floating license keys to the exchange 101 (step 702).

The exchange 101 that has received the input of the license keys stores the input license keys in the system database 305. Since the licenses that have been input are the floating licenses, they are stored in floating license storage areas 602 and 603 of the corresponding Software identifier: License function 601. In the present embodiment, “4” are stored in both areas 602 and 603 of the corresponding Software identifier: License function 601 (step 703).

The terminal registration processing and license confirmation processing are then performed in the same manner as in the case of the node lock license. In this stage, the floating licenses have not been moved to the user database and are not available.

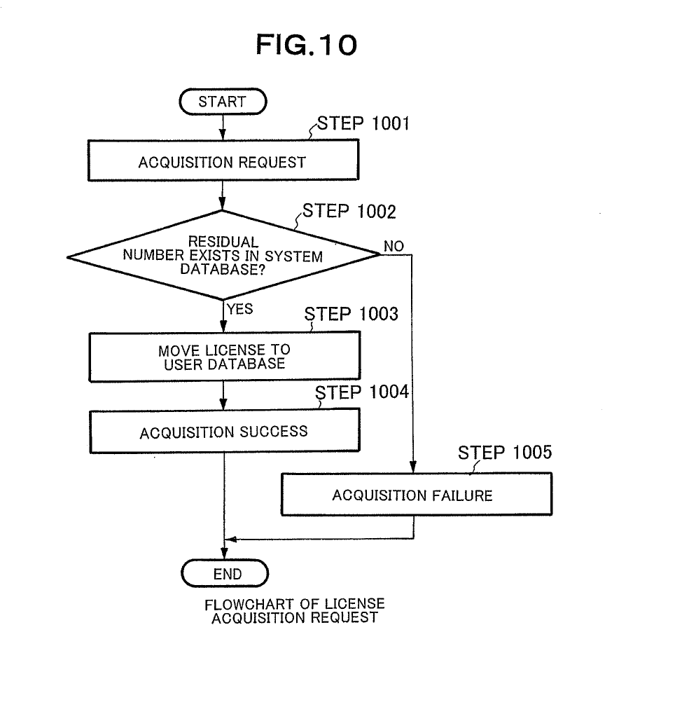

Then, processing of acquiring the floating license is executed in each terminal. Next, with reference to a flowchart of FIG. 10, the floating license acquisition processing will be described.

It is assumed that the user B uses the desk-top terminal 104 to execute software with a software identifier of “SOFTPHONE” for registration and acquires one floating license of the “VIDEO” function. The desk-top terminal 104 transmits to the exchange 101 its own hardware ID “22-22-22-22-22-22”, user ID “userB” of the user B, password “userBPass” software identifier “SOFTPHONE”, software serial number “001”, request function “VIDEO”, and number of requests “1” (step 1001).

The exchange 101 searches the area 602 of the system database 305 to check whether the residual number of the floating license of the received request function “VIDEO” of the software “SOFTPHONE” is not less than 1 (step 1002).

When the residual number is less than 1, i.e., no floating license exists, the exchange 101 determines that the acquisition has failed and transmits the fact of the acquisition failure to the terminal 104 (step 1005).

It is assumed that the floating license exists. In this case, the exchange 101 reduces a value stored in Residual number of floating licenses 602 by “1” which is the received number of requests and stores the “1” in License function: number of licenses 504 of the user B in the user database 304. At this time, “_FL” is added to the license function so as to indicate that the relevant function is acquired by means of the floating license (step 1003).

Thereafter, the exchange 101 transmits the fact of the acquisition success to the terminal 104 (step 1004).

The software “SOFTPHONE” on the terminal 104 that has received the fact of the authentication success executes the license confirmation processing of FIG. 9 in the same manner as in the case of the node lock license. As a result, after confirming the acquired license, the software “SOFTPHONE” enables the function “VIDEO”. At this time, a license function indicated by a result of the confirmation processing is “VIDEO_FL”. Since the same function is provided irrespective of whether the acquired license is a floating license or node lock license, the software “SOFTPHONE” enables the license function indicated by the confirmation result.

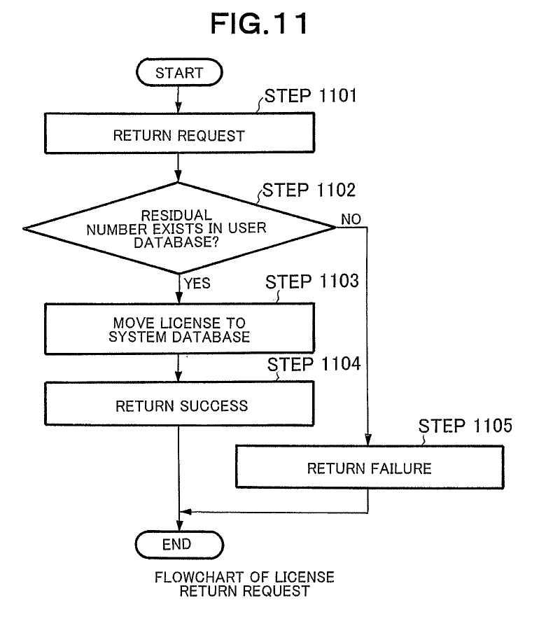

Next, with reference to a flowchart of FIG. 11, a case where the floating license is returned from the terminal will be described.

It is assumed that the user B uses the desk-top terminal 104 to execute software with a software identifier of “SOFTPHONE” for registration and, as a result, has one floating license of “VIDEO” function. The desk-top terminal 104 transmits to the exchange its own hardware ID of “22-22-22-22-22-22”, user ID “userB” of the user B, password “userBPass”, software identifier “SOFTPHONE”, software serial number “001”, function to be returned “VIDEO_FL”, and the number of returns “1” (step 1101).

The exchange 101 checks the user database 304 to determine whether the number of licenses of the license function “VIDEO_FL” in License function: Number of licenses 504 of the user B is not less than “1” (step 1102).

When the residual number is less than 1, i.e., no floating license exists, the exchange 101 determines that the return has failed and transmits the fact of the return failure to the terminal 104 (step 1105).

When the residual number is not less than “1”, the exchange 101 reduces the number of licenses of license function “VIDEO_FL” in the number of licenses storage area 504 by “1” and increases a value of corresponding Residual number of floating licenses 602 by “1” (step 1103).

Thereafter, the exchange 101 transmits the fact of the return success to the terminal 104 (step 1104).

The software “SOFTPHONE” on the terminal 104 that has received the fact of the authentication success executes the license confirmation processing of FIG. 9 in the same manner as in the case of the node lock license. As a result, after confirming the return of the license, the software “SOFTPHONE” disables the function “VIDEO”.

Since the acquired floating license is stored in the same location as the node lock license on the user database, it is possible to use the floating license only by executing the terminal registration processing of FIG. 8 without execution of the return processing or reacquisition processing even when a use terminal is changed over to another one, as in the case of the node lock license.

Further, the license acquired as the node lock license is treated as in the same manner as the floating license after being registered in the user database. That is, it is possible to change the node lock license into the floating license only by executing the return processing of FIG. 11 in the same manner as in the case of the floating license.

In the case where a device like the optional terminal A-1 108 or optional terminal A-2 109 having no key board or a display I/F is used, that is, in the case where it is difficult to input the user ID or password, the user ID is set to a specific fixed character string, and user databases 501 to 504 for the specified character strings are previously implemented on the exchange 101 side.

Further, a configuration may be employed in which software identifier that the optional terminal uses is defined as one for software that operates on the optional terminal Thus, in the case where thus defined software identifier is used to execute the registration processing of FIG. 8, it is possible to generate the user ID 501 and password 502 based on “use software identifier+software serial number” using the same algorithm between the optional terminal side and exchange side.

In this case, when two or more optional terminals are connected to the exchange, “software serial number” is made able to be changed by a setting made on the optional terminal side so that the same “software serial number” is not used among the optional terminals.

If, in this configuration, the default value of the “software serial number” set at the time of shipping is fixed to, e.g., “001” and the registration processing of the second and subsequent optional terminals is erroneously performed using the software serial number “001” without change, the registration is made using the same user ID as the first optional terminal with the result that the use terminal changeover processing is performed. Thus, there is a possibility that the first optional terminal cannot use the license. In order to cope with this problem, the default value is set to a serial number that is not commonly used, such as “000”. That is, in the case where the serial number “001” is used to perform the registration processing, the exchange returns a registration failure response.

The exchange and license issuance server may be realized by a hardware, software or the combination of them.

What is claimed is:

1. A license management system comprising:
a system database configured to store and correlate:
a set of functions and software, said functions configured to be licensed to users;
a residual number of floating licenses, said residual number of floating licenses representing unused licenses;
a maximum number of the floating licenses, said maximum number of the floating licenses representing an upper limit of a number of the floating licenses; and
a set of a number of unused node lock licenses and hardware IDs of terminals which correspond to the unused node lock licenses;
a user database configured to store and correlate:
a user ID of a user who uses at least one licensed function of respective software;
a user password which corresponds to the user ID;
a set of a software identifier of the used software, a serial number of the used software, and a hardware ID of a terminal which is used by the user; and
a set of a used licensed function name and a number of licenses for each licensed function;
a license issuing server configured to issue node license keys each of which includes a hardware ID, a software identifier, a licensed function name and a number of licenses for each licensed function;
a first unit configured to add a record to the system database on the basis of a node license key issued by the license issuing server, said first unit being disposed in an exchange, the added record including:
a set of the software identifier and the licensed function name included in the node license key;
the maximum number of floating licenses corresponding to the number of licenses included in the node license key; and
a set of the number of unused node lock licenses and a hardware ID corresponding to the hardware ID and the number of licenses included in the node license key;
a second unit, being disposed in the exchange, configured to, if registering a first terminal to be used with the exchange, determine whether or not a set of a user ID and a user password which are transmitted from the first terminal coincides with a set of a user ID and a user password which are stored in the user database;
a third unit, being disposed in the exchange, configured to, if registering the first terminal with the exchange, store the hardware ID included in the node license key to a record of the user database, said record corresponding to the user ID and the node license key which are transmitted from the first terminal to the exchange;
a fourth unit, being disposed in the exchange, configured to, after registering the first terminal with the exchange, confirm whether or not the hardware ID included in the node license key coincides with a hardware ID of a record of the system database, the hardware ID being of the first terminal which corresponds to an unused node lock license, the system database including a software identifier which coincides with the software identifier included in the node license key;
a fifth unit, being disposed in the exchange;
wherein the fifth unit is configured to transfer a software identifier included in a record, which includes a hardware ID which corresponds to the hardware ID included in the node license key, and the hardware ID included in the node license key, to a field of a record of the user database, the field including a set of the software identifier, a serial number of the software and the hardware ID, the record including a user ID transmitted from the first terminal to the exchange;
wherein the fifth unit is configured to transfer the licensed function name included in the node license key included in a record, which includes a hardware ID which corresponds to the hardware ID included in the node license key, to a field of a record of the user database, the field including a set of the licensed function name and the number of licenses of the function, the record including the user ID transmitted from the first terminal to the exchange;
a sixth unit, being disposed in the first terminal, configured to transmit a request for confirming holding licenses to the exchange, the request containing the hardware ID of the first terminal, the user ID of the user who uses the first terminal, a password which corresponds to the user ID, a software identifier and a software serial number;
a seventh unit, being disposed in the exchange, configured to attempt to retrieve at least one record from the user database including the user ID, the user password, and the hardware ID, which are included in the request for confirming holding licenses, and configured to, if the at least one record is retrieved, obtain the licensed function and the number of licenses described in the retrieved at least one record;
an eighth unit, being disposed in the exchange, configured to transmit the licensed function and the number of licenses to the first terminal;
a ninth unit, being disposed in the first terminal, configured to validate the licensed function which is received from the exchange and the number of licenses of the function received from the exchange;
a tenth unit, being disposed in a second terminal, configured to transmit a hardware ID of the second terminal, a user ID, a user password, a software identifier and a software serial number to the exchange;
an eleventh unit, being disposed in the exchange, configured to confirm whether or not a set of a user ID and a user password, which corresponds to a set of the user ID and the user password received from the second terminal, exists in the user database;
a twelfth unit, being disposed in the exchange, configured to rewrite the hardware ID of a record of a user database, the record including the user ID, the user password, and the software identifier which are received from the second terminal, to the hardware ID received from the second terminal;
a thirteenth unit, being disposed in the exchange, configured to confirm that the hardware ID of the second terminal received from the second terminal does not exist in an unused node lock license storage area of a record of the system database, the record including a set of a software identifier and a licensed function name which correspond to a set of the software identifier and licensed function name which are received from the second terminal; and
a fourteenth unit, being disposed in the exchange, configured to notify the second terminal of the success of the confirmation by the thirteenth unit, if a result of the confirmation by the thirteenth unit is successful.

2. The license management system according to claim 1, wherein the eighth unit is configured such that, if the seventh unit determines that there is no record in the user database including the user ID, the user password and the hardware ID, which are included in the request for confirming holding licenses received from the first terminal, then the eighth unit notifies the first terminal that there is no such record in the user database, and
wherein the ninth unit is configured such that, if the ninth unit is notified that there is no record in the user database including the user ID, the user password and the hardware ID included in the request for confirming holding licenses received from the first terminal, then the ninth unit invalidates a licensed function which has been previously validated in correspondence with the user ID, the user password and the hardware ID.

3. A license management method executed in a system including a system database, a user database and a license issuing server, the method comprising:
issuing, by the license issuing server, a node license key which includes a hardware ID, a software identifier, a licensed function name and a number of licenses of each licensed function;
a first operation which adds a record to the system database on the basis of the node license key;
wherein the system database stores and correlates:
a set of functions and software, said functions configured to be licensed to users;
a residual number of floating licenses, said residual number of floating licenses representing unused licenses;
a maximum number of the floating licenses, said maximum number of the floating licenses representing an upper limit of a number of the floating licenses; and
a set of a number of unused node lock licenses and hardware IDs of terminals which correspond to the unused node lock licenses;
wherein said first operation is executed in an exchange, the added record including:
a set of the software identifier and the licensed function name included in the node license key;
the maximum number of floating licenses corresponding to the number of licenses included in the node license key; and
a set of the number of unused node lock licenses and a hardware ID corresponding to the hardware ID and the number of licenses included in the node license key;
a second operation, being executed in the exchange, which accesses the user database;
wherein the user database stores and correlates:
a user ID of a user who uses at least one licensed function of respective software;
a user password which corresponds to the user ID;
a set of a software identifier of the used software, a serial number of the used software, and a hardware ID of a terminal which is used by the user; and
a set of a used licensed function name and a number of licenses for each licensed function;
wherein the second operation comprises, if registering a first terminal to be used with the exchange, determining whether or not a set of a user ID and a user password which are transmitted from the first terminal coincides with a set of a user ID and a user password which are stored in the user database;
a third operation, being executed in the exchange, configured to, if registering the first terminal with the exchange, store the hardware ID included in the node license key to a record of the user database, said record corresponding to the user ID and the node license key which are transmitted from the first terminal to the exchange;
a fourth operation, being executed in the exchange, which, after registering the first terminal with the exchange, confirms whether or not the hardware ID included in the node license key coincides with a hardware ID of a record of the system database, the hardware ID being of the first terminal which corresponds to an unused node lock license, the system database including a software identifier which coincides with the software identifier included in the node license key;
a fifth operation, being executed in the exchange, which transfers a software identifier included in a record, which includes a hardware ID which corresponds to the hardware ID included in the node license key, and the hardware ID included in the node license key to a field of a record of the user database, the field including a set of the software identifier, a serial number of the software and the hardware ID, the record including a user ID transmitted from the first terminal to the exchange;
wherein the fifth operation transfers the licensed function name included in the node license key included in a record, which includes a hardware ID which corresponds to the hardware ID included in the node license key, to a field of a record of the user database, the field including a set of the licensed function name and the number of licenses of the function, the record including the user ID transmitted from the first terminal to the exchange;
a sixth operation, being executed in the first terminal, which transmits a request for confirming holding licenses to the exchange, the request containing the hardware ID of the first terminal, the user ID of the user who uses the first terminal, a password which corresponds to the user ID, a software identifier and a software serial number;
a seventh operation, being executed in the exchange, which attempts to retrieve at least one record from the user database including the user ID, the user password, and the hardware ID, which are included in the request for confirming holding licenses, and which, if the at least one record is retrieved, obtains the licensed function and the number of licenses described in the retrieved at least one record;
an eighth operation, executed in the exchange, which transmits the licensed function and the number of licenses to the first terminal;
a ninth operation, being executed in the first terminal, which validates the licensed function which is received from the exchange and the number of licenses of the function received from the exchange;
a tenth operation, being executed in a second terminal, which transmits a hardware ID of the second terminal, a user ID, a user password, a software identifier and a software serial number to the exchange;
an eleventh operation, being executed in the exchange, which confirms whether or not a set of a user ID and a user password, which corresponds to a set of the user ID and the user password received from the second terminal, exists in the user database;
a twelfth operation, being executed in the exchange, which rewrites the hardware ID of a record of a user database, the record including the user ID, the user password, and the software identifier which are received from the second terminal, to the hardware ID received from the second terminal;
a thirteenth operation, being executed in the exchange, which confirms that the hardware ID of the second terminal received from the second terminal does not exist in an unused node lock license storage area of a record of the system database, the record including a set of a software identifier and a licensed function name which correspond to a set of the software identifier and licensed function name which are received from the second terminal; and
a fourteenth operation, being executed in the exchange, which notifies the second terminal of the success of the confirmation by the thirteenth operation, if a result of the confirmation by the thirteenth operation is successful.

4. The license management method according to claim 3, wherein if the seventh operation determines that there is no record in the user database including the user ID, the user password and the hardware ID, which are included in the request for confirming holding licenses received from the first terminal, then the eighth operation notifies the first terminal that there is no such record in the user database; and
wherein if the ninth operation is notified that there is no record in the user database including the user ID, the user password and the hardware ID included in the request for confirming holding licenses received from the first terminal, then the ninth operation invalidates the licensed function which has been previously validated in correspondence with the user ID, the user password and the hardware ID.

5. A non-transitory computer-readable medium on which a program is recorded, said program causing a computer, if executed, to perform a license management method in a system including a system database, a user database and a license issuing server, the method comprising:
issuing, by the license issuing server, a node license key which includes a hardware ID, a software identifier, a licensed function name and a number of licenses of each licensed function;
a first operation which adds a record to the system database on the basis of the node license key;
wherein the system database stores and correlates:
a set of functions and software, said functions configured to be licensed to users;
a residual number of floating licenses, said residual number of floating licenses representing unused licenses;
a maximum number of the floating licenses, said maximum number of the floating licenses representing an upper limit of a number of the floating licenses; and
a set of a number of unused node lock licenses and hardware IDs of terminals which correspond to the unused node lock licenses;
wherein said first operation is executed in an exchange, the added record including:
a set of the software identifier and the licensed function name included in the node license key;
the maximum number of floating licenses corresponding to the number of licenses included in the node license key; and
a set of the number of unused node lock licenses and a hardware ID corresponding to the hardware ID and the number of licenses included in the node license key;
a second operation, being executed in the exchange, which accesses the user database;
wherein the user database stores and correlates:
a user ID of a user who uses at least one licensed function of respective software;
a user password which corresponds to the user ID;
a set of a software identifier of the used software, a serial number of the used software, and a hardware ID of a terminal which is used by the user; and
a set of a used licensed function name and a number of licenses for each licensed function;
wherein the second operation comprises, if registering a first terminal to be used with the exchange, determining whether or not a set of a user ID and a user password which are transmitted from the first terminal coincides with a set of the user ID and a user password which are stored in the user database;
a third operation, being executed in the exchange, configured to, if registering the first terminal with the exchange, store the hardware ID included in the node license key to a record of the user database, said record corresponding to the user ID and the node license key which are transmitted from the first terminal to the exchange;
a fourth operation, being executed in the exchange, which, after registering the first terminal with the exchange, confirms whether or not the hardware ID included in the node license key coincides with a hardware ID of a record of the system database, the hardware ID being of the first terminal which corresponds to an unused node lock license, the system database including a software identifier which coincides with the software identifier included in the node license key;
a fifth operation, being executed in the exchange, which transfers a software identifier included in a record which includes a hardware ID which corresponds to the hardware ID included in the node license key, and the hardware ID included in the node license key to a field of a record of the user database, the field including a set of the software identifier, a serial number of the software and the hardware ID, the record including a user ID transmitted from the first terminal to the exchange;
wherein the fifth operation transfers the licensed function name included in the node license key included in a record, which includes a hardware ID which corresponds to the hardware ID included in the node license key, to a field of a record of the user database, the field including a set of the licensed function name and the number of licenses of the function, the record including the user ID transmitted from the first terminal to the exchange;
a sixth operation, being executed in the first terminal, which transmits a request for confirming holding licenses to the exchange, the request containing the hardware ID of the first terminal, the user ID of the user who uses the first terminal, a password which corresponds to the user ID, a software identifier and a software serial number;
a seventh operation, being executed in the exchange, which attempts to retrieve at least one record from the user database including the user ID, the user password, and the hardware ID which are included in the request for confirming holding licenses, and which, if the at least one record is retrieved, obtains the licensed function and the number of licenses described in the retrieved at least one record;
an eighth operation, executed in the exchange, which transmits the licensed function and the number of licenses to the first terminal;
a ninth operation, being executed in the first terminal, which validates the licensed function which is received from the exchange and the number of licenses of the function received from the exchange;
a tenth operation, being executed in a second terminal, which transmits a hardware ID of the second terminal, a user ID, a user password, a software identifier and a software serial number to the exchange;
an eleventh operation, being executed in the exchange, which confirms whether or not a set of a user ID and a user password, which corresponds to a set of the user ID and the user password received from the second terminal, exists in the user database;
a twelfth operation, being executed in the exchange, which rewrites the hardware ID of a record of a user database, the record including the user ID, the user password, and the software identifier which are received from the second terminal, to the hardware ID received from the second terminal;
a thirteenth operation, being executed in the exchange, which confirms that the hardware ID of the second terminal received from the second terminal does not exist in an unused node lock license storage area of a record of the system database, the record including a set of a software identifier and a licensed function name which correspond to a set of the software identifier and licensed function name which are received from the second terminal; and
a fourteenth operation, being executed in the exchange, which notifies the second terminal of the success of the confirmation by the thirteenth operation, if a result of the confirmation by the thirteenth operation is successful.

6. The non-transitory computer-readable medium according to claim 5, wherein if the seventh operation determines that there is no record in the user database including the user ID, the user password and the hardware ID, which are included in the request for confirming holding licenses received from the first terminal, then the eighth operation notifies the first terminal that there is no such record in the user database; and
wherein if the ninth operation is notified that there is no record in the user database including the user ID, the user password and the hardware ID included in the request for confirming holding licenses received from the first terminal, then the ninth operation invalidates the licensed function which has previously been validated in correspondence with the user ID, the user password and the hardware ID.
